(19) United States
(12) Patent Application Publication
(10) Pub. No.: US 2026/0169829 A1
(43) Pub. Date: Jun. 18, 2026

(54) CHUNKY PARTIAL LOAD TO STORE FORWARDING FOR PIPELINE LOADS

(71) Applicant: Intel Corporation, Santa Clara, CA (US)

(72) Inventors: Mark DECHENE, Hillsboro, OR (US); Michael MEEUWSEN, Hillsboro, OR (US); Meenakshi MARATHE, Hillsboro, OR (US); Sudeepto MAJUMDAR, Hillsboro, OR (US)

(73) Assignee: Intel Corporation, Santa Clara, CA (US)

(21) Appl. No.: 18/984,856

(22) Filed: Dec. 17, 2024

(51) Int. Cl. G06F 9/52

(52) U.S. Cl. CPC G06F 9/52

(57) ABSTRACT

Techniques for a processor, method, and system to implement a chunky partial load to store forwarding for pipelined loads. A chunky partial logic identifies overlap of partial load to store forwarding in a load pipeline for a load, decomposes the load into chunks of uniform size for issuance of each chunk as a separate chunky load and schedules the issuance of the chunks. A chunky partial register receives and stores the chunks decomposed into the chunks and issues the chunks separately into the load pipeline as a load operation.

### BACKGROUND

Modern CPUs support Load to Store forwarding to improve latency of loads which are dependent on stores. When the load requires data that is only partially covered by a store, or spread across multiple stores, then partial store forwarding is employed, enabling the load to be serviced from bytes gathered from several distinct locations in the machine (e.g. Store Buffer, Fill Buffer, Cache).

Various algorithms have been employed to implement partial forwarding, with different performance characteristics. Typical partial forwarding solutions implement greedy algorithms which attempt to gather the bytes required to service a load in as few passes as possible. While this reduces the power required to service the load, it increases computational complexity, and creates a dependency between passes. The machine waits for the completion of the current pass to know the bytes which are to be fetched in the subsequent pass. As pipeline depths increase, this creates a substantial latency penalty, because sequential accesses cannot be pipelined. For a pipeline depth T, requiring N passes, each supplying a variable number of bytes, the best case latency is N*T. For a 16-byte load, N will range from 2 to 16.

### BRIEF DESCRIPTION OF DRAWINGS

Various examples in accordance with the present disclosure will be described with reference to the drawings, in which:

FIG. 1 illustrates an example of a load dispatch that has a partial overlap with a store according to some examples of the disclosure.

FIG. 2 illustrates a portion of a processor 200 for implementing the CPF for a load pipeline according to some examples of the disclosure.

FIG. 3 illustrates a chunk dispatch to a load pipe for chunk data collection according to some examples of the disclosure.

FIG. 4 illustrates a last chunk dispatch to a load pipe for chunk data merge according to some examples of the disclosure.

FIG. 5 illustrates chunk processing in the load pipe and chunk collection at the end of the load pipe according to some examples of the disclosure.

FIG. 6 illustrates writing of a successful chunk merge to a storage location at the completion of CPF according to some examples of the disclosure.

FIG. 7 illustrates a situation where a previous chunk through the load pipe captured for collection triggers a failure according to some examples of the disclosure.

FIG. 8 illustrates a method for performing the CPF for a load according to some examples of the disclosure.

FIG. 9 illustrates examples of computing hardware to process a load instruction.

FIG. 10 illustrates an example method performed by a processor to process a load instruction.

FIG. 11 illustrates an example computing system.

FIG. 12 illustrates a block diagram of an example processor and/or System on a Chip (SoC) that may have one or more cores and an integrated memory controller.

FIG. 13(A) is a block diagram illustrating both an example in-order pipeline and an example register renaming, out-of-order issue/execution pipeline according to examples.

FIG. 13(B) is a block diagram illustrating both an example in-order architecture core and an example register renaming, out-of-order issue/execution architecture core to be included in a processor according to examples.

FIG. 14 illustrates examples of execution unit(s) circuitry.

FIG. 15 is a block diagram of a register architecture according to some examples.

FIG. 16 illustrates examples of an instruction format.

FIG. 17 illustrates examples of an addressing information field.

### DETAILED DESCRIPTION

The present disclosure relates to methods, apparatus and systems for chunky partial load to store forwarding for pipelined loads. According to some examples, the technique described in the disclosure pertaining to chunky partial load to store forwarding simplifies the process of servicing loads through partial forwarding by breaking the load into uniform chunks, each of which is serviced by the machine as a separate load. These loads are scheduled into the memory unit load pipeline in adjacent cycles. This technique eliminates the dependency between passes, and, in some examples, improves the best-case latency to T+N−1, instead of N*T.

Furthermore, the Chunky Partial Forwarding (CPF) algorithm provides predictable latency for partial load to store forwarding, which scales more readily with pipeline depth, and number of passes required to service the load. This provides significant performance benefits for Central Processing Units (CPUs) with large Level 1 (L1) caches, and large store buffers.

CPF is a partial forwarding algorithm, together with a chunky partial load logic, that identifies and schedules loads for partial forwarding by decomposing the loads into chunks of uniform size, and issuing each chunk as a unique load. The results of each chunk load are stored in a register at the end of the pipeline, and the original load is completed if all chunks complete successfully. The technique scales well with pipeline depth and provides a low hardware cost for implementation.

CPF implementation requires three modifications to a typical load pipeline. First, loads are to be identified and marked as candidates for CPF, and the chunk size selected. Second, scheduling of the load pipeline is to account for CPF support, by allocating a register and logic (e.g., controller) to track the scheduling of chunks into the load pipe. Finally, the chunked loads are collected at the end of the pipeline, where completion of each chunk is tracked to determine the overall success or failure of the original load.

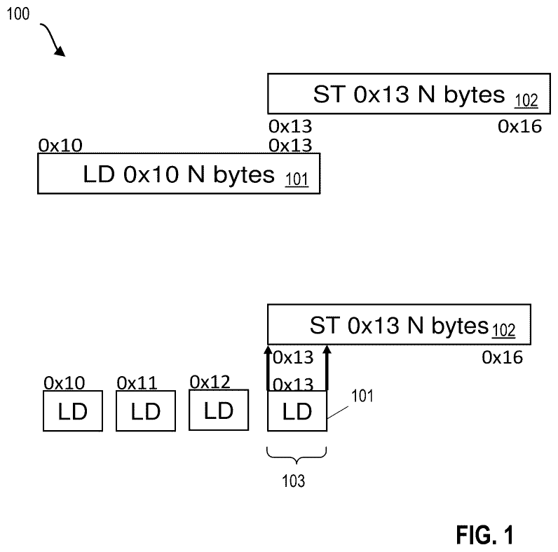

FIG. 1 illustrates an example of a load dispatch that has a partial overlap with a store according to some examples of the disclosure. As shown in diagram 100, a load 101 has an N-byte range of 0x10-0x13, while a store has an N-byte range of 0x13-0x16. Load identification for CPF is managed through existing store forwarding checks. When a load checks a store buffer, the loads byte range is compared to that of the store identified as a forwarding candidate. If the overlap is incomplete, the load will be marked for CPF. In FIG. 1, the load 101 is incomplete due to the overlap with the store 102, as noted for byte range 0x13. Hence, the load 101 is a candidate for CPF. A chunk size for CPF is selected based on the alignment of the load, store and their overlap. For the diagram 100, if the overlap 0x13 is 4-byte aligned, then a 4-byte size chunk 103 can be selected. Other examples can implement other chunk sizes based on byte size, alignment and size of overlap. In some examples where a certain byte size cannot be achieved or the bytes are not aligned between the load and store, 1-byte chunks can be used. In FIG. 1, each chunk size is 4-bytes.

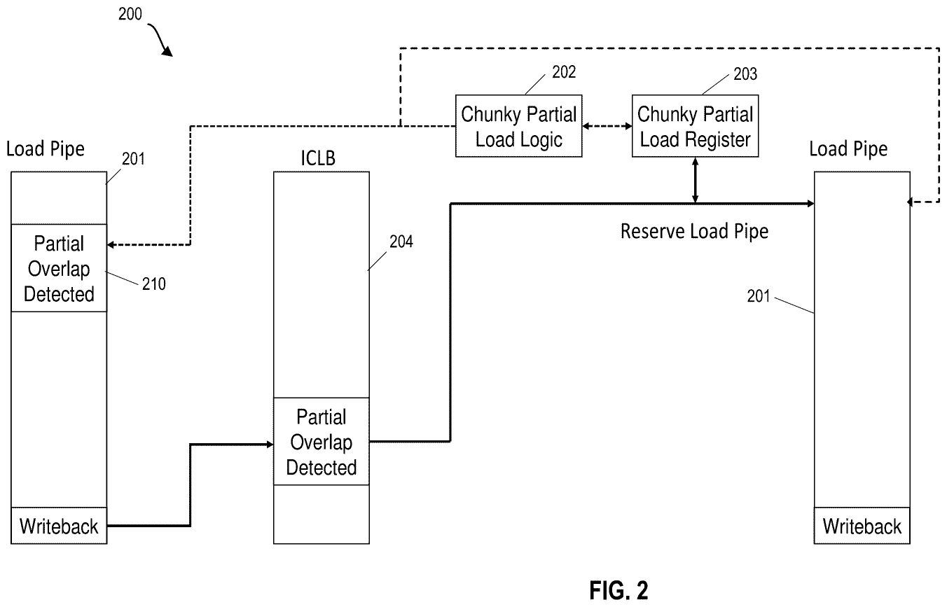

FIG. 2 illustrates a portion of a processor 200 for implementing the CPF for a load pipeline according to some examples of the disclosure. FIG. 2 shows a load pipe 201 for executing the load 101. A chunky partial load logic 202 works in conjunction with a chunky partial load register 203 to process load chunks, when a partial overlap of load to store is detected 210 in the pipeline 201. Because pipeline 201 processes the load 101, it is also referred to as load pipe 201. Also present is an Incomplete Load Buffer (ICLB) 204. The ICLB 204 holds loads that have been executed (e.g., by a corresponding address generation unit), but have not yet completed (e.g., have not retired). Note that the load pipe 201 at the right side of the drawing is the same load pipe 201 at the left side of the drawing. The duplication is for the purpose of explanation. However, some examples may use a separate pipeline.

In operation, the load 101 enters the load pipe 201 at the top and when completed successfully, performs a writeback at the bottom of the load pipe 201. CPF loads arbitrate for the load pipe in the same manner as a non-CPF loads. Once a partial overlap is detected, the chunky partial load logic 202 allocates the chunky partial load register (hereinafter noted as CPR 203) to hold the inputs to the first pipe stage, and provides a counter and supporting logic to track chunks (e.g., 4-byte chunks) to compute the base address of each chunk.

A load may be marked for chunky mode when it completes a pass down the load pipe, and would have completed, except that it failed the data overlap check. When this occurs, the load operation sets the chunky bit in the ICLB 204. When the load eventually schedules, it will proceed in chunky mode.

In some examples, at the time of selection, the load's chunk size will be chosen. The default chunk size is 1 byte. It will be promoted to 4-byte chunks if the following conditions are met:
Load Linear Address [1:0]=2′b00 (The load is 4-byte aligned.)
Load Linear Address End [1:0]=2′b11 (the load is a multiple of 4 bytes)
The matching store overlaps with the load in multiples of 4 bytes. Given the alignment and overlap requirements.

A chunk size bit(s) indicating the chunk size is stored in the ICLB along with a chunky bit, indicating that this load is to be processed as a chunk. Defeature bits can be added for chunky selection to prevent 4-byte chunk selection and/or to prevent chunky selection completely.

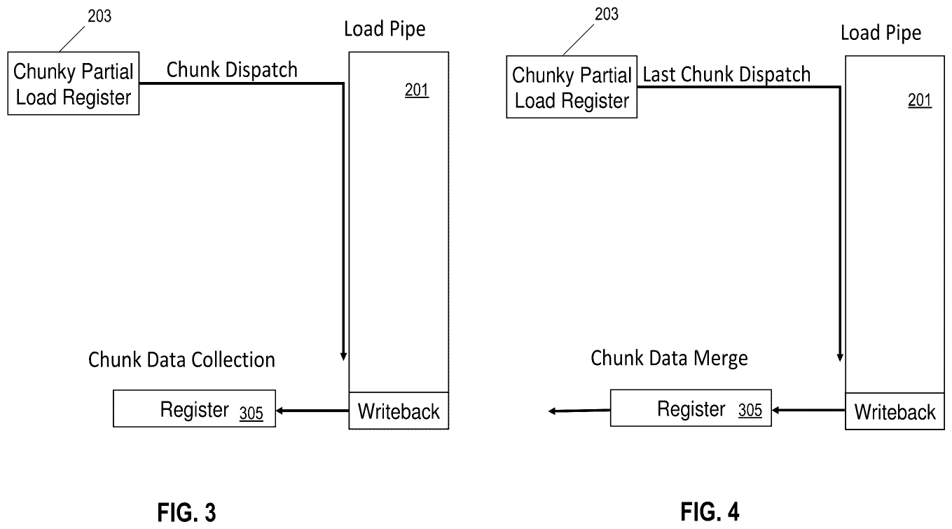

Loads that are detected as chunky schedule pipeline 201 to suppress early wakeup and prepare to acquire the CPR 203. If the CPR 203 is free, chunky load will setup all its payload to be written in to the CPR and set the valid bit next cycle. Chunky load attempts to arbitrate for its first chunk into main load pipeline 201. FIG. 3 shows each chunk dispatch from the CPR 203 to enter the load pipe 201. Each chunk 103 issues as a load down the load pipe 201, asserting an additional bit to indicate that the load is a CPF chunk.

The chunky partial load logic 202 and the CPR 203 hold the state of the chunky load while it is being executed, and control the issuing of individual chunks down the load pipe 201. The chunky partial load logic 202 sits at the beginning of the load pipe 201 and holds the address and control data from the ICLB 204, and is responsible for issuing chunk loads down the load pipe 201, and eventually issuing the wakeup.

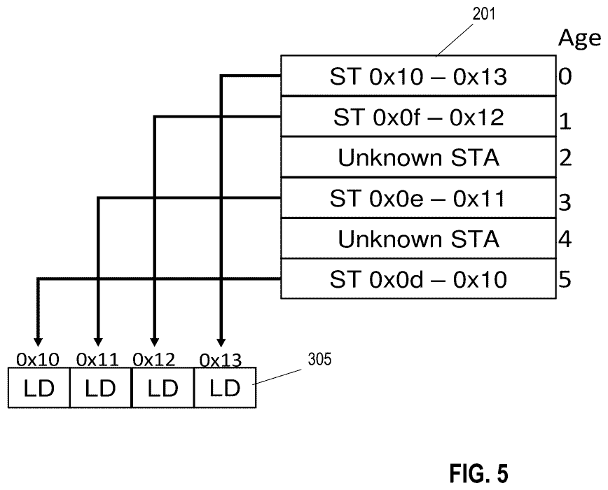

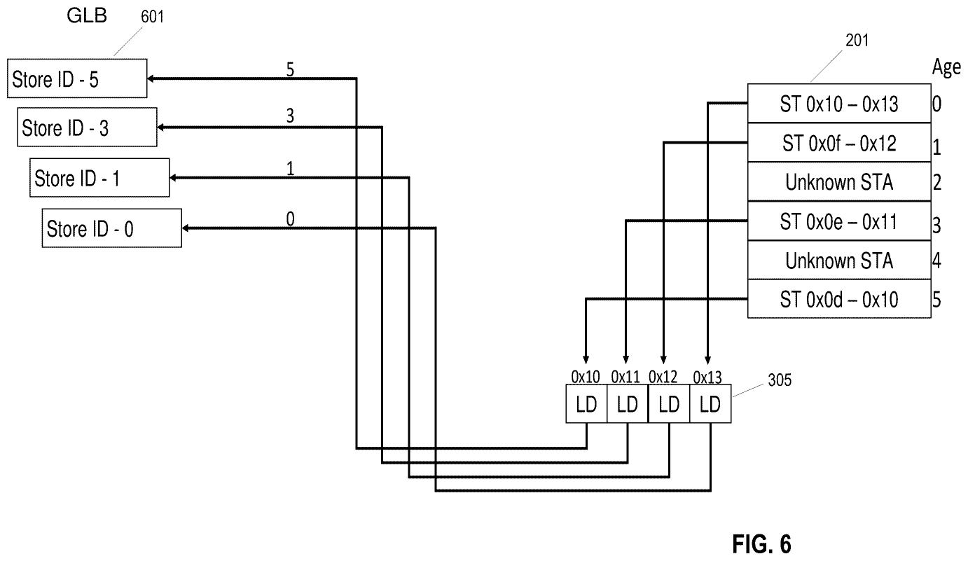

Chunked loads proceed down the load pipe 201 as shown in FIG. 3 in the usual manner as for other loads, but in separate chunks as shown in FIG. 5. In the final stage of the pipeline, successful loads typically write back their data and signal completion. Instead, CPF loads write data into a data register 305, which accumulates the data until the final chunk. When the last chunk of the original load is dispatched (0x13 in the example), a last chunk indication is asserted. FIG. 4 shows the dispatch of the last chunk. The bytes of the register 305 are enabled based on the count of chunks completed by the CPR 203. In addition, a bit is maintained for the life of the CPF load to track success or failure of each chunk. The first chunk that fails to complete will set this bit, and update the loads state accordingly. If the last chunk completes without having set the failure bit, then all data is in the register 305 and may be written back. In some examples, the chunky data collection can be achieved by the pipeline 201, a buffer or some other collection mechanism, instead of the register 305.

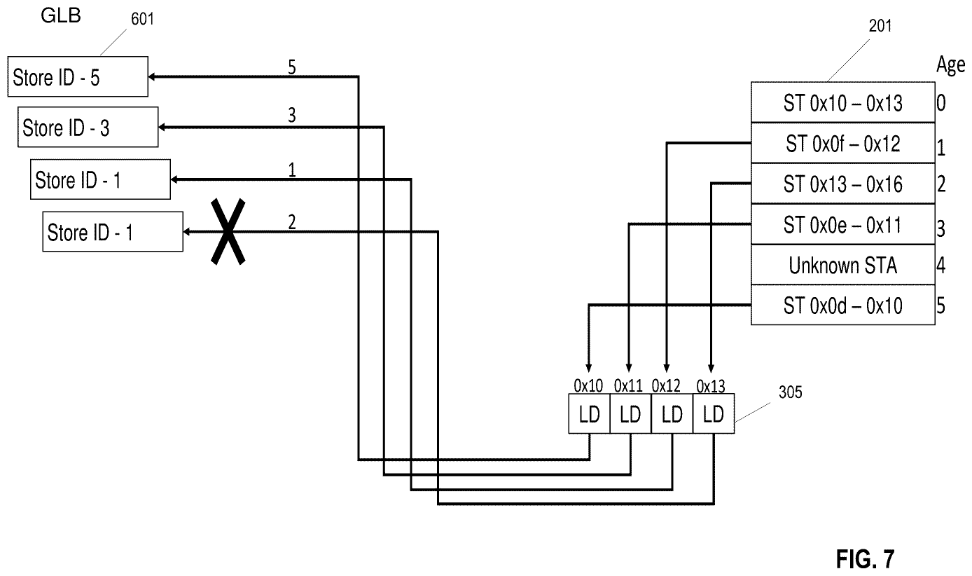

When the last chunk of the original load is dispatched (0x13 in the example), a last chunk indication is asserted. The bytes of the register 305 are enabled based on the count of chunks completed by the CPR 203. In addition, a bit (e.g., chunky_bad bit) is maintained for the life of the CPF load to track success or failure of each chunk. The first chunk that fails to complete will set this bit, and update the loads state accordingly. If the last chunk completes without having set the failure bit set, then all data is in the register 305 and may be written back, as shown in FIG. 6.

In FIG. 6, the successfully collected and merged chunks (e.g., in register 305) are written to a storage location, such as a global storage buffer (GLB) 601. In some examples, the collected and merged chunks are sent to a memory, such as a cache memory (e.g., L1 cache memory).

The chunky_bad bit is maintained (e.g., chunky partial logic 202, CPR 203 or register 305) which indicates whether the chunky load in progress is on track to complete. The bit is cleared at reset, or the first chunk of a chunky load. It gets set on the first chunk that fails to complete successfully.

The first chunk of a load that fails to complete is responsible for updating the ICLB state. For the chunk that failed to complete, that chunk's block-code information is updated into the ICLB 204. Remaining chunks will not update ICLB 204. Failing chunks will also clear the chunky bit in the ICLB 204 so that subsequent attempts of the load will re-assess the need for chunky mode.

Because the first failing chunk updates the ICLB 204 when it reaches the end of the load pipe 201, it opens an opportunity for the same load to reschedule by clearing the bit in ICLB 204. However, the CPR 203 does not know that the load is bad, and will continue to send the remaining chunks, which will block the load from scheduling again. If the failing chunk is early enough, there will be sufficient time for the load to reschedule and take the load pipe 201 immediately after the last chunk of the chunky load completes. This case results in the same load being in the load pipe in multiple stages simultaneously. This condition should be benign as it is guaranteed that the earlier chunky load will not write back.

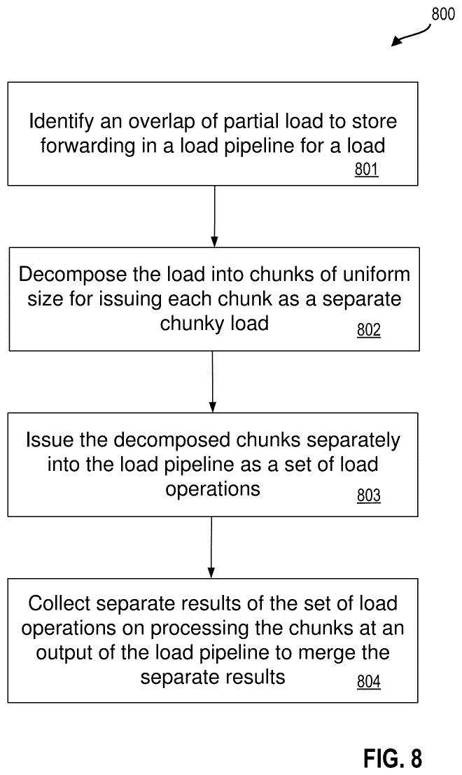

Furthermore, as shown in FIG. 7, if a situation arises where a previous chunk through the load pipe 201 is collected by register 305, the Store identity (ID) will identify that the collection is incorrect, thereby indicating failure, as shown in FIG. 7.

When a load binds to data in chunky mode, each pass through the pipe updates the GLB 601 according to the conditions for a normal load. Because the load may bind to data multiple times, there is an additional condition that must be met with in updating the Store ID. Only the oldest Store ID is written into the GLB 601. The GLB 601 does not support read-modify-write operations, so the determination is handled in the load pipe. The previously written Store ID and a valid indication is stored at the end of the load pipe. If the load needs to update a Store ID in the GLB 601, having passed unknown stores, it compares its Store ID against the ID of the previous chunk to determine if it is valid.

Furthermore, any chunk going down the load pipe 201 could be canceled. The cancellation of the chunk will result in the chunky load being dropped. The clear mechanism is identical for that of normal loads. The chunk will have its load value de-asserted, but the chunky indication will remain asserted. This condition is used to identify that the load has been cleared. A canceled chunky load is marked as bad to prevent writeback, but doesn't update ICLB 204.

To ensure nothing escapes, the CPR 203 will be checked for clear conditions against the alignment, similar to the ICLB 204. The CPR 203 valid bit is cleared, and a new load (chunky or otherwise) may be scheduled at the next opportunity. The CPR 203 does not indicate last-chunk in the load pipe in this case. However, the first chunk of the next chunky load will resolve this condition. Even though the CPR 203 is cleared, an arbitrary number of chunks may exist in the pipe and will drain. Some or all of these may signal cancellation.

In some examples, one or more of the following basic rules can be implemented for loads to enter and execute in chunky mode.
Loads are marked for chunky mode after failing to forward from the store data buffer due to a partial data overlap.
A load marked for chunky mode will enter chunky mode the next time it is scheduled from the ICLB.
The chunky load blocks the ICLB and lower priority requests from issuing down the pipe until it issues all chunks. Higher priority requests may interrupt the chunky load causing it to stall until the pipe is free.
The default chunk size is one byte. A load may instead attempt 4-byte chunks if certain alignment conditions are met.
Either half of a split load may enter chunky mode if normal conditions are met.
256-bit loads, or the split halves of 256-bit loads are prevented from entering chunky mode. This reduces the size of the CPR and reduces complexity in rotating split requests.
Chunky loads will not send a wakeup to out of order until the final chunk enters the pipe successfully.
Chunky loads will not write-back to out of order until the final chunk (and all prior) successfully complete and bind to data.
Chunky loads that are unable to complete a chunk will continue to block the pipe until the last chunk is scheduled. This is to reduce complexity of validating all possible cancel alignments.
Each chunk that completes successfully is considered data-bound, and updates the GLB.

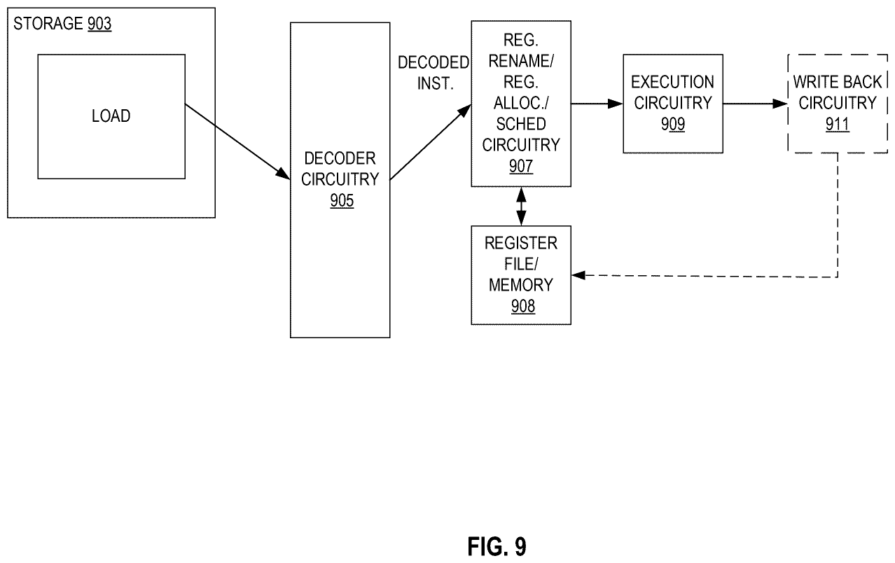

FIG. 8 illustrates a flow diagram of a method 400 which can be practiced by a processor as described above that operates on a chunky partial load logic and chunky partial register with attended pipeline and storage. At operation 801, the method 400 identifies an overlap of partial load to store forwarding in a load pipeline for a load. At operation 802, the method 500 decomposes the load into chunks of uniform size for issuing each chunk as a separate chunky load. At operation 803, the method 500 issues the decomposed chunks separately into the load pipeline as a set of load operations. At operation 804, the method collects separate results of the set of load operations on processing the chunks at an output of the load pipeline to merge the separate results.

This method provides predictable latency for partial forwarding that scales well with pipeline depth. Given a pipeline depth of T and a load of N chunks, the load can complete in T+N−1 cycles, while greedy algorithms requiring feedback will take T*n cycles, where n<=N. While the greedy algorithms may use fewer chunks, the CPF algorithm has superior latency for deeper pipelines.

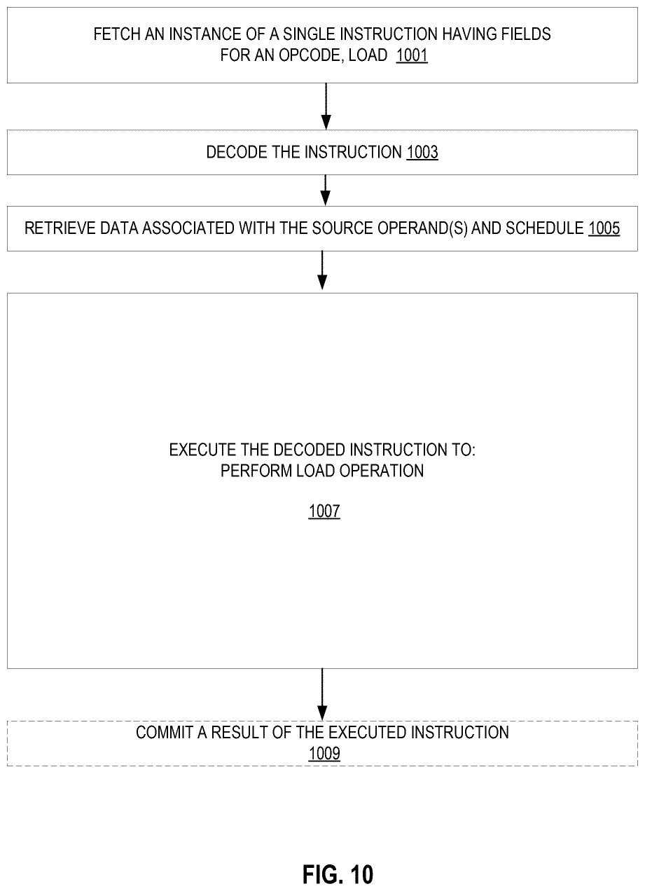

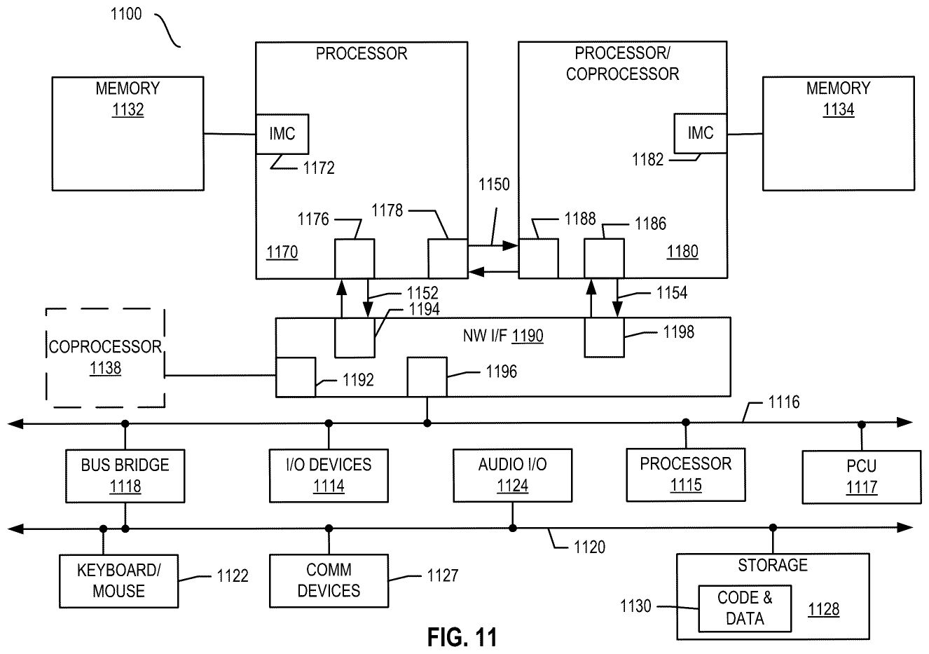

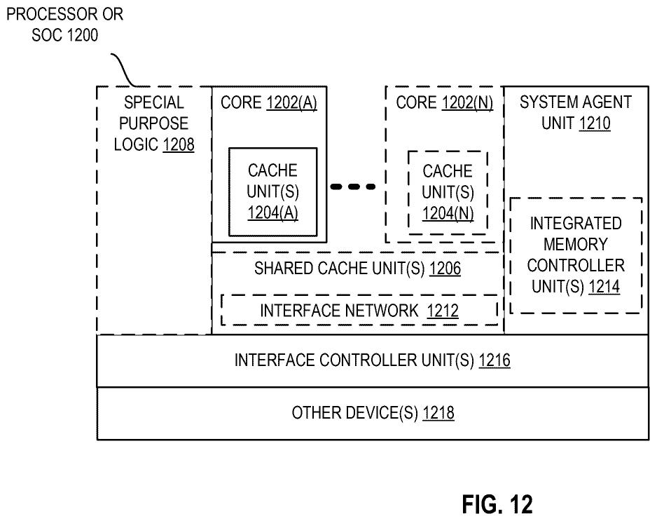

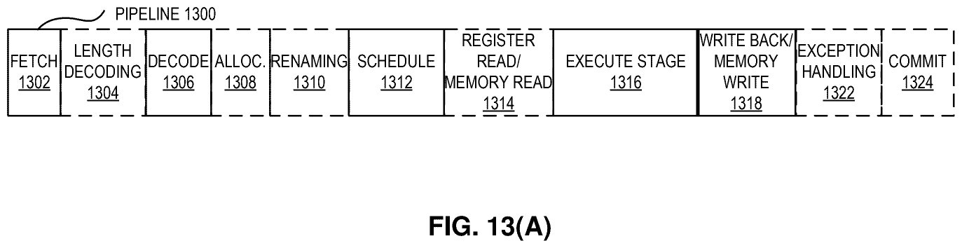

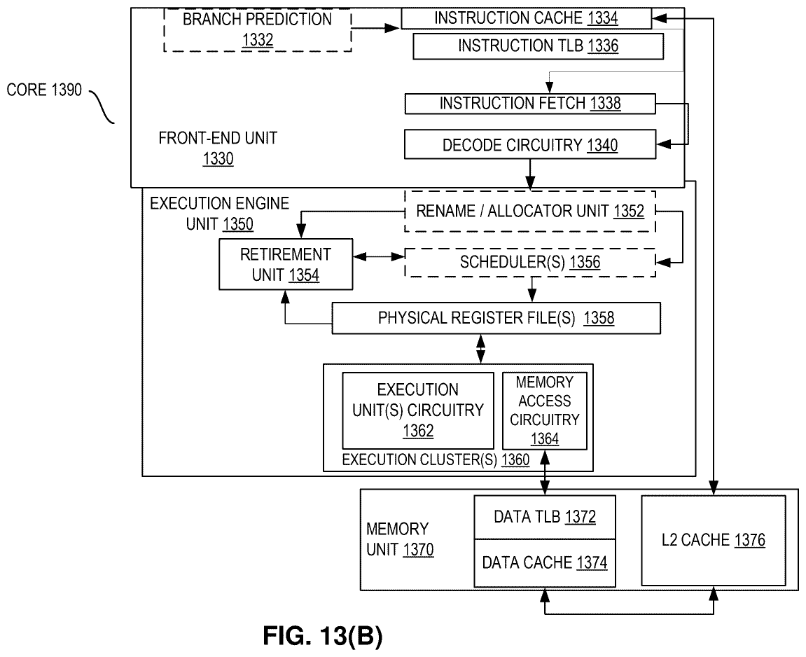

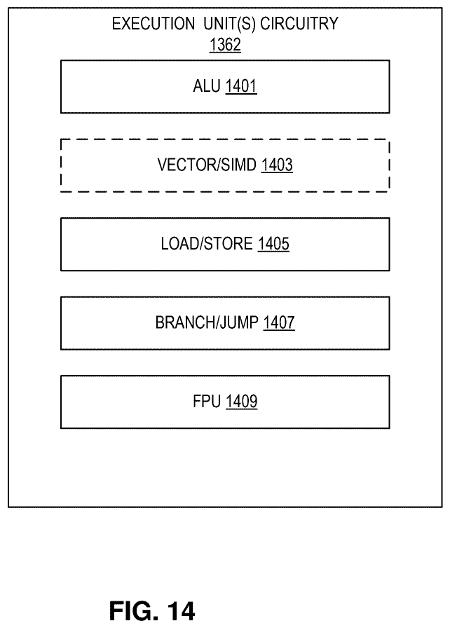

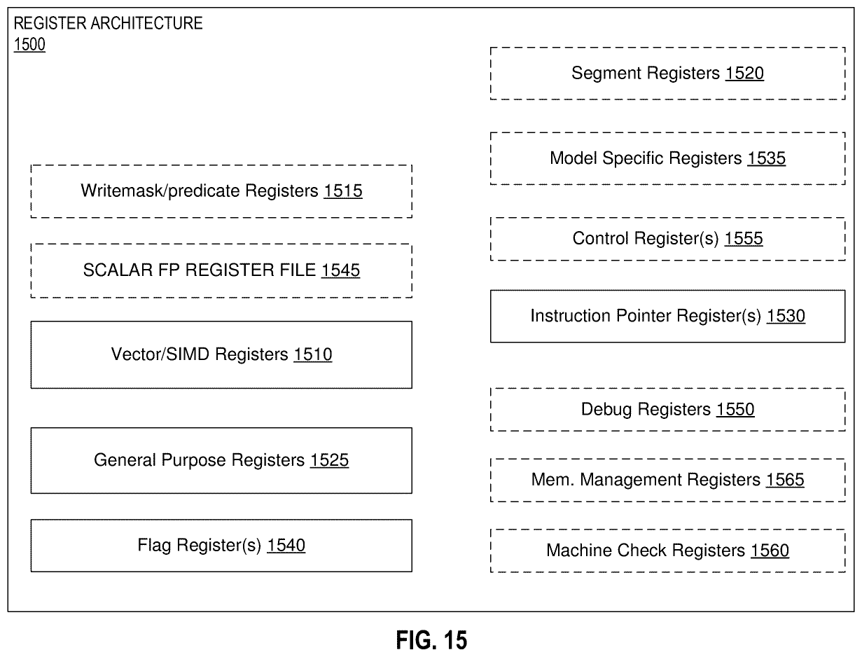

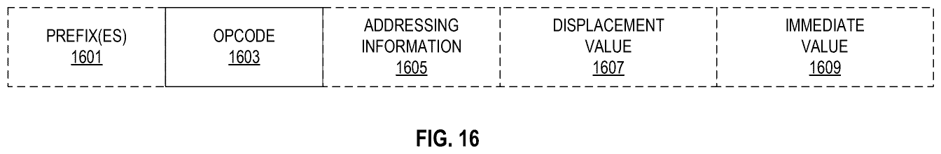

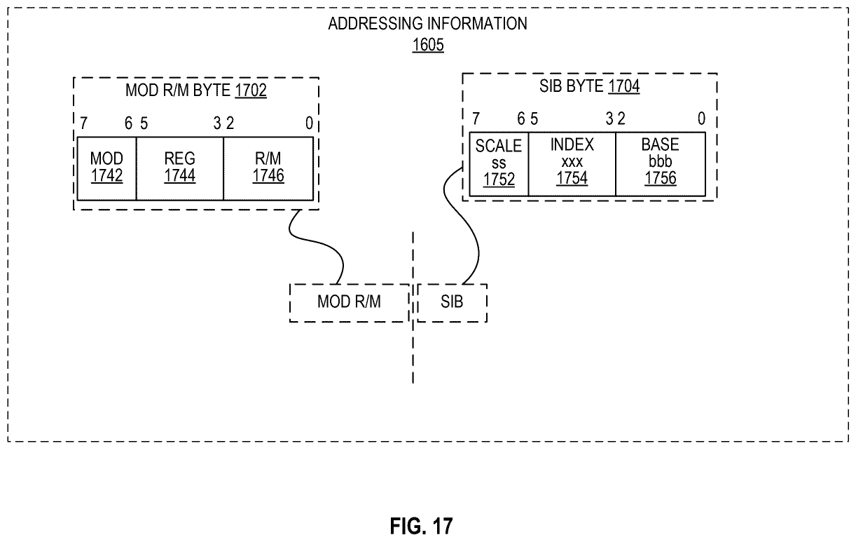

Although the disclosure describes some examples above, other techniques can implement the same or equivalent techniques described. The processor 200 can be implemented in a processor or coprocessor shown in FIG. 9, FIG. 11 and FIG. 12 performing operations (FIG. 10) to execute a load instruction. FIG. 13A shows a pipeline that can be duplicated in a processor, including the processor 200. FIG. 13B shows an example system having execution units and memory units to operate on Loads and Stores to perform the above described operations. FIG. 14 shows another example of an execution unit to perform the functions described herein. FIG. 15 shows a register architecture showing various registers that can be used with the processor 200. FIG. 16 and FIG. 17 show an instruction format and addressing information which can be used for a Load instructions to perform the load operations described herein.

FIG. 9 illustrates examples of computing hardware to process a load instruction. As illustrated, storage 903 stores a load instruction 901 to be executed.

The instruction 901 is received by decoder circuitry 905. For example, the decoder circuitry 905 receives this instruction from fetch circuitry (not shown). The instruction may be in any suitable format, such as that describe with reference to FIG. 16 below. In an example, the instruction includes fields for an opcode and a destination identifier. In some examples, the sources and destination are registers, and in other examples one or more are memory locations. In some examples, one or more of the sources may be an immediate operand.

More detailed examples of at least one instruction format for the instruction will be detailed later. The decoder circuitry 905 decodes the instruction into one or more operations. In some examples, this decoding includes generating a plurality of micro-operations to be performed by execution circuitry (such as execution circuitry 909). The decoder circuitry 905 also decodes instruction prefixes.

In some examples, register renaming, register allocation, and/or scheduling circuitry 907 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry out of an instruction pool (e.g., using a reservation station in some examples).

Registers (register file) and/or memory 908 store data as operands of the instruction to be operated by execution circuitry 909. Example register types include packed data registers, general purpose registers (GPRs), and floating-point registers.

Execution circuitry 909 executes the decoded instruction.

In some examples, retirement/write back circuitry 911 architecturally commits the destination register into the registers or memory 908 and retires the instruction.

FIG. 10 illustrates an example method performed by a processor to process a load instruction. For example, a processor core as shown in FIG. 13(B), a pipeline as detailed below, etc., performs this method.

At 1001, an instance of single instruction is fetched. For example, a load instruction is fetched. In some examples, the instruction further includes a field for a writemask. In some examples, the instruction is fetched from an instruction cache. The opcode indicates a load to be perform.

The fetched instruction is decoded at 1003. For example, the fetched load instruction is decoded by decoder circuitry such as decoder circuitry 905 or decode circuitry 1340 detailed herein.

Data values associated with the source operands of the decoded instruction are retrieved when the decoded instruction is scheduled at 1005. For example, when one or more of the source operands are memory operands, the data from the indicated memory location is retrieved. At 1007, the decoded instruction is executed by execution circuitry (hardware) 909 shown in FIG. 9, or execution cluster(s) 1360 shown in FIG. 13(B).

In some examples, the instruction is committed or retired at 1009.

### Example Systems

FIG. 11 illustrates an example computing system. Multiprocessor system 1100 is an interfaced system and includes a plurality of processors or cores including a first processor 1170 and a second processor 1180 coupled via an interface 1150 such as a point-to-point (P-P) interconnect, a fabric, and/or bus. In some examples, the first processor 1170 and the second processor 1180 are homogeneous. In some examples, first processor 1170 and the second processor 1180 are heterogenous. Though the example multiprocessor system 1100 is shown to have two processors, the system may have three or more processors, or may be a single processor system. In some examples, the computing system is a system on a chip (SoC).

Processors 1170 and 1180 are shown including integrated memory controller (IMC) circuitry 1172 and 1182, respectively. Processor 1170 also includes interface circuits 1176 and 1178; similarly, second processor 1180 includes interface circuits 1186 and 1188. Processors 1170, 1180 may exchange information via the interface 1150 using interface circuits 1178, 1188. IMCs 1172 and 1182 couple the processors 1170, 1180 to respective memories, namely a memory 1132 and a memory 1134, which may be portions of main memory locally attached to the respective processors.

Processors 1170, 1180 may each exchange information with a network interface (NW I/F) 1190 via individual interfaces 1152, 1154 using interface circuits 1176, 1194, 1186, 1198. The network interface 1190 (e.g., one or more of an interconnect, bus, and/or fabric, and in some examples is a chipset) may optionally exchange information with a co-processor 1138 via an interface circuit 1192. In some examples, the co-processor 1138 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator,, a data streaming accelerator, data graph operations, or the like.

A shared cache (not shown) may be included in either processor 1170, 1180 or outside of both processors, yet connected with the processors via an interface such as P-P interconnect, such that either or both processors' local cache information may be stored in the shared cache if a processor is placed into a low power mode.

Network interface 1190 may be coupled to a first interface 1116 via interface circuit 1196. In some examples, first interface 1116 may be an interface such as a Peripheral Component Interconnect (PCI) interconnect, a PCI Express interconnect or another I/O interconnect. In some examples, first interface 1116 is coupled to a power control unit (PCU) 1117, which may include circuitry, software, and/or firmware to perform power management operations with regard to the processors 1170, 1180 and/or co-processor 1138. PCU 1117 provides control information to a voltage regulator (not shown) to cause the voltage regulator to generate the appropriate regulated voltage. PCU 1117 also provides control information to control the operating voltage generated. In various examples, PCU 1117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1117 is illustrated as being present as logic separate from the processor 1170 and/or processor 1180. In other cases, PCU 1117 may execute on a given one or more of cores (not shown) of processor 1170 or 1180. In some cases, PCU 1117 may be implemented as a microcontroller (dedicated or general-purpose) or other control logic configured to execute its own dedicated power management code, sometimes referred to as P-code. In yet other examples, power management operations to be performed by PCU 1117 may be implemented externally to a processor, such as by way of a separate power management integrated circuit (PMIC) or another component external to the processor. In yet other examples, power management operations to be performed by PCU 1117 may be implemented within BIOS or other system software.

Various I/O devices 1114 may be coupled to first interface 1116, along with a bus bridge 1118 which couples first interface 1116 to a second interface 1120. In some examples, one or more additional processor(s) 1115, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 1116. In some examples, second interface 1120 may be a low pin count (LPC) interface. Various devices may be coupled to second interface 1120 including, for example, a keyboard and/or mouse 1122, communication devices 1127 and storage circuitry 1128. Storage circuitry 1128 may be one or more non-transitory machine-readable storage media as described below, such as a disk drive or other mass storage device which may include instructions/code and data 1130 and may implement the storage 903 in some examples. Further, an audio I/O 1124 may be coupled to second interface 1120. Note that other architectures than the point-to-point architecture described above are possible. For example, instead of the point-to-point architecture, a system such as multiprocessor system 1100 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

FIG. 12 illustrates a block diagram of an example processor and/or SoC 1200 that may have one or more cores and an integrated memory controller. The solid lined boxes illustrate a processor and/or SoC 1200 with a single core 1202(A), system agent unit circuitry 1210, and a set of one or more interface controller unit(s) circuitry 1216, while the optional addition of the dashed lined boxes illustrates an alternative processor and/or SoC 1200 with multiple cores 1202(A)-(N), a set of one or more integrated memory controller unit(s) circuitry 1214 in the system agent unit circuitry 1210, and special purpose logic 1208, as well as a set of one or more interface controller unit(s) circuitry 1216. Note that the processor and/or SoC 1200 may be one of the processors 1170 or 1180, or co-processor 1138 or 1115 of FIG. 11.

Thus, different implementations of the processor and/or SoC 1200 may include: 1) a CPU with the special purpose logic 1208 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like(which may include one or more cores, not shown), and the cores 1202(A)-(N) being one or more general purpose cores (e.g., general purpose in-order cores, general purpose out-of-order cores, or a combination of the two); 2) a co-processor with the cores 1202(A)-(N) being a large number of special purpose cores intended primarily for graphics and/or scientific (throughput); and 3) a co-processor with the cores 1202(A)-(N) being a large number of general purpose in-order cores. Thus, the processor and/or SoC 1200 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 1200 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1204(A)-(N) within the cores 1202(A)-(N), a set of one or more shared cache unit(s) circuitry 1206, and external memory (not shown) coupled to the set of integrated memory controller unit(s) circuitry 1214. The set of one or more shared cache unit(s) circuitry 1206 may include one or more mid-level caches, such as level 2 (L2), level 3 (L3), level 4 (L4), or other levels of cache, such as a last level cache (LLC), and/or combinations thereof. While in some examples interface network circuitry 1212 (e.g., a ring interconnect) interfaces the special purpose logic 1208 (e.g., integrated graphics logic), the set of shared cache unit(s) circuitry 1206, and the system agent unit circuitry 1210, alternative examples use any number of well-known techniques for interfacing such units. In some examples, coherency is maintained between one or more of the shared cache unit(s) circuitry 1206 and cores 1202(A)-(N). In some examples, interface controller unit(s) circuitry 1216 couple the cores 1202(A)-(N) to one or more other devices 1218 such as one or more I/O devices, storage, one or more communication devices (e.g., wireless networking, wired networking, etc.), etc.

In some examples, one or more of the cores 1202(A)-(N) are capable of multi-threading. The system agent unit circuitry 1210 includes those components coordinating and operating cores 1202(A)-(N). The system agent unit circuitry 1210 may include, for example, power control unit (PCU) circuitry and/or display unit circuitry (not shown). The PCU may be or may include logic and components needed for regulating the power state of the cores 1202(A)-(N) and/or the special purpose logic 1208 (e.g., integrated graphics logic). The display unit circuitry is for driving one or more externally connected displays.

The cores 1202(A)-(N) may be homogenous in terms of instruction set architecture (ISA). Alternatively, the cores 1202(A)-(N) may be heterogeneous in terms of ISA; that is, a subset of the cores 1202(A)-(N) may be capable of executing an ISA, while other cores may be capable of executing only a subset of that ISA or another ISA.

In FIG. 13(A), a processor pipeline 1300 includes a fetch stage 1302, an optional length decoding stage 1304, a decode stage 1306, an optional allocation (Alloc) stage 1308, an optional renaming stage 1310, a schedule (also known as a dispatch or issue) stage 1312, an optional register read/memory read stage 1314, an execute stage 1316, a write back/memory write stage 1318, an optional exception handling stage 1322, and an optional commit stage 1324. One or more operations can be performed in each of these processor pipeline stages. For example, during the fetch stage 1302, one or more instructions are fetched from instruction memory, and during the decode stage 1306, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 1306 and the register read/memory read stage 1314 may be combined into one pipeline stage. In some examples, during the execute stage 1316, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 13(B) may implement the pipeline 1300 as follows: 1) the instruction fetch circuitry 1338 performs the fetch and length decoding stages 1302 and 1304; 2) the decode circuitry 1340 performs the decode stage 1306; 3) the rename/allocator unit circuitry 1352 performs the allocation stage 1308 and renaming stage 1310; 4) the scheduler(s) circuitry 1356 performs the schedule stage 1312; 5) the physical register file(s) circuitry 1358 and the memory unit circuitry 1370 perform the register read/memory read stage 1314; the execution cluster(s) 1360 perform the execute stage 1316; 6) the memory unit circuitry 1370 and the physical register file(s) circuitry 1358 perform the write back/memory write stage 1318; 7) various circuitry may be involved in the exception handling stage 1322; and 8) the retirement unit circuitry 1354 and the physical register file(s) circuitry 1358 perform the commit stage 1324.

FIG. 13(B) shows a processor core 1390 including front-end unit circuitry 1330 coupled to execution engine unit circuitry 1350, and both are coupled to memory unit circuitry 1370. The core 1390 may be a reduced instruction set architecture computing (RISC) core, a complex instruction set architecture computing (CISC) core, a very long instruction word (VLIW) core, or a hybrid or alternative core type. As yet another option, the core 1390 may be a special-purpose core, such as, for example, a network or communication core, compression engine, co-processor core, general purpose computing graphics processing unit (GPGPU) core, graphics core, or the like.

The front-end unit circuitry 1330 may include branch prediction circuitry 1332 coupled to instruction cache circuitry 1334, which is coupled to an instruction translation lookaside buffer (TLB) 1336, which is coupled to instruction fetch circuitry 1338, which is coupled to decode circuitry 1340. In some examples, the instruction cache circuitry 1334 is included in the memory unit circuitry 1370 rather than the front-end unit circuitry 1330. The decode circuitry 1340 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1340 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 1340 may be implemented using various different mechanisms. Examples of suitable mechanisms include, but are not limited to, look-up tables, hardware implementations, programmable logic arrays (PLAs), microcode read only memories (ROMs), etc. In some examples, the core 1390 includes a microcode ROM (not shown) or other medium that stores microcode for certain macroinstructions (e.g., in decode circuitry 1340 or otherwise within the front-end unit circuitry 1330). In some examples, the decode circuitry 1340 includes a micro-operation (micro-op) or operation cache (not shown) to hold/cache decoded operations, micro-tags, or micro-operations generated during the decode or other stages of the processor pipeline 1300. The decode circuitry 1340 may be coupled to rename/allocator unit circuitry 1352 in the execution engine unit circuitry 1350.

The execution engine unit circuitry 1350 includes the rename/allocator unit circuitry 1352 coupled to retirement unit circuitry 1354 and a set of one or more scheduler(s) circuitry 1356. The scheduler(s) circuitry 1356 represents any number of different schedulers, including reservations stations, central instruction window, etc. In some examples, the scheduler(s) circuitry 1356 can include arithmetic logic unit (ALU) scheduler/scheduling circuitry, ALU queues, address generation unit (AGU) scheduler/scheduling circuitry, AGU queues, etc. The scheduler(s) circuitry 1356 is coupled to the physical register file(s) circuitry 1358. Each of the physical register file(s) circuitry 1358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 1358 includes vector registers unit circuitry, writemask registers unit circuitry, and scalar register unit circuitry. These register units may provide architectural vector registers, vector mask registers, general-purpose registers, etc. The physical register file(s) circuitry 1358 is coupled to the retirement unit circuitry 1354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1354 and the physical register file(s) circuitry 1358 are coupled to the execution cluster(s) 1360. The execution cluster(s) 1360 includes a set of one or more execution unit(s) circuitry 1362 and a set of one or more memory access circuitry 1364. The execution unit(s) circuitry 1362 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). In some examples, execution unit(s) circuitry 1362 may include hardware to support functionality for instructions for one or more of a compression engine, graphics processing, neural-network processing, in-memory analytics, matrix operations, cryptographic operations, data streaming operations, data graph operations, etc.

While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1356, physical register file(s) circuitry 1358, and execution cluster(s) 1360 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1364). It should also be understood that where separate pipelines are used, one or more of these pipelines may be out-of-order issue/execution and the rest in-order.

In some examples, the execution engine unit circuitry 1350 may perform load store unit (LSU) address/data pipelining to an Advanced Microcontroller Bus (AMB) interface (not shown), and address phase and writeback, data phase load, store, and branches.

The set of memory access circuitry 1364 is coupled to the memory unit circuitry 1370, which includes data TLB circuitry 1372 coupled to data cache circuitry 1374 coupled to level 2 (L2) cache circuitry 1376. In some examples, the memory access circuitry 1364 may include load unit circuitry, store address unit circuitry, and store data unit circuitry, each of which is coupled to the data TLB circuitry 1372 in the memory unit circuitry 1370. The instruction cache circuitry 1334 is further coupled to the level 2 (L2) cache circuitry 1376 in the memory unit circuitry 1370. In some examples, the instruction cache 1334 and the data cache 1374 are combined into a single instruction and data cache (not shown) in L2 cache circuitry 1376, level 3 (L3) cache circuitry (not shown), and/or main memory. The L2 cache circuitry 1376 is coupled to one or more other levels of cache and eventually to a main memory.

The core 1390 may support one or more instructions sets (e.g., the x86 instruction set architecture (optionally with some extensions that have been added with newer versions); the MIPS instruction set architecture; the ARM instruction set architecture (optionally with optional additional extensions such as NEON, etc.); RISC instruction set architecture), including the instruction(s) described herein. In some examples, the core 1390 includes logic to support a packed data instruction set architecture extension (e.g., AVX1, AVX2, AVX512, AMX, etc.), thereby allowing the operations used by many multimedia applications to be performed using packed data.

### Example Execution Unit(s) Circuitry

FIG. 14 illustrates examples of execution unit(s) circuitry, such as execution unit(s) circuitry 1362 of FIG. 13(B). As illustrated, execution unit(s) circuitry 1362 may include one or more ALU circuits 1401, optional vector/single instruction multiple data (SIMD) circuits 1403, load/store circuits 1405, branch/jump circuits 1407, and/or Floating-point unit (FPU) circuits 1409. ALU circuits 1401 perform integer arithmetic and/or Boolean operations. Vector/SIMD circuits 1403 perform vector/SIMD operations on packed data (such as SIMD/vector registers). Load/store circuits 1405 execute load and store instructions to load data from memory into registers or store from registers to memory. Load/store circuits 1405 may also generate addresses. Branch/jump circuits 1407 cause a branch or jump to a memory address depending on the instruction. FPU circuits 1409 perform floating-point arithmetic. The width of the execution unit(s) circuitry 1362 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

FIG. 15 is a block diagram of a register architecture 1500 according to some examples. As illustrated, the register architecture 1500 includes vector/SIMD registers 1510 that vary from 128-bit to 1,024 bits width. In some examples, the vector/SIMD registers 1510 are physically 512-bits and, depending upon the mapping, only some of the lower bits are used. For example, in some examples, the vector/SIMD registers 1510 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1500 includes writemask/predicate registers 1515. For example, in some examples, there are 8 writemask/predicate registers (sometimes called k0 through k7) that are each 16-bit, 32-bit, 64-bit, or 128-bit in size. Writemask/predicate registers 1515 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1515 corresponds to a data element position of the destination. In other examples, the writemask/predicate registers 1515 are scalable and consists of a set number of enable bits for a given vector element (e.g., 8 enable bits per 64-bit vector element).

The register architecture 1500 includes a plurality of general-purpose registers 1525. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1500 includes scalar floating-point (FP) register file 1545 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1540 (e.g., EFLAGS, RFLAGS, etc.) store status and control information for arithmetic, compare, and system operations. For example, the one or more flag registers 1540 may store condition code information such as carry, parity, auxiliary carry, zero, sign, and overflow. In some examples, the one or more flag registers 1540 are called program status and control registers.

Segment registers 1520 contain segment points for use in accessing memory. In some examples, these registers are referenced by the names CS, DS, SS, ES, FS, and GS.

Model specific registers or machine specific registers (MSRs) 1535 control and report on processor performance. Most MSRs 1535 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 1560 consist of control, status, and error reporting MSRs that are used to detect and report on hardware errors. Control register(s) 1555 (e.g., CR0-CR4) determine the operating mode of a processor (e.g., processor 1170, 1180, 1138, 1115, and/or 1200) and the characteristics of a currently executing task. In some examples, MSRs 1535 are a subset of control registers 1555.

One or more instruction pointer register(s) 1530 store an instruction pointer value. Debug registers 1550 control and allow for the monitoring of a processor or core's debugging operations.

Memory (mem) management registers 1565 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1500 may, for example, be used in register file/memory 908, or physical register file(s) circuitry 13 58.

### Instruction Set Architectures

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 16 illustrates examples of an instruction format. As illustrated, an instruction may include multiple components including, but not limited to, one or more fields for: one or more prefixes, an opcode, addressing information (e.g., register identifiers, memory addressing information, etc.), a displacement value, and/or an immediate value. Note that some instructions utilize some or all the fields of the format whereas others may only use the field for the opcode 1603. In some examples, the order illustrated is the order in which these fields are to be encoded, however, it should be appreciated that in other examples these fields may be encoded in a different order, combined, etc.

The prefix(es) f 1601, when used, modifies an instruction. In some examples, one or more prefixes are used to repeat string instructions (e.g., 0xF0, 0xF 2, 0xF 3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1603 is used to at least partially define the operation to be performed upon a decoding of the instruction. In some examples, a primary opcode encoded in the opcode field 1603 is one, two, or three bytes in length. In other examples, a primary opcode can be a different length. An additional 3-bit opcode field is sometimes encoded in another field.

The addressing information field 1605 is used to address one or more operands of the instruction, such as a location in memory or one or more registers. FIG. 17 illustrates examples of the addressing information field 1605. In this illustration, an optional MOD R/M byte 1702 and an optional Scale, Index, Base (SIB) byte 1704 are shown. The MOD R/M byte 1702 and the SIB byte 1704 are used to encode up to two operands of an instruction, each of which is a direct register or effective memory address. Note that both of these fields are optional in that not all instructions include one or more of these fields. The MOD R/M byte 1702 includes a MOD field 1742, a register (reg) field 1744, and R/M field 1746.

The content of the MOD field 1742 distinguishes between memory access and non-memory access modes. In some examples, when the MOD field 1742 has a binary value of 11 (11b), a register-direct addressing mode is utilized, and otherwise a register-indirect addressing mode is used.

The register field 1744 may encode either the destination register operand or a source register operand or may encode an opcode extension and not be used to encode any instruction operand. The content of register field 1744, directly or through address generation, specifies the locations of a source or destination operand (either in a register or in memory). In some examples, the register field 1744 is supplemented with an additional bit from a prefix (e.g., prefix 1601) to allow for greater addressing.

The R/M field 1746 may be used to encode an instruction operand that references a memory address or may be used to encode either the destination register operand or a source register operand. Note the R/M field 1746 may be combined with the MOD field 1742 to dictate an addressing mode in some examples.

The SIB byte 1704 includes a scale field 1752, an index field 1754, and a base field 1756 to be used in the generation of an address. The scale field 1752 indicates a scaling factor. The index field 1754 specifies an index register to use. In some examples, the index field 1754 is supplemented with an additional bit from a prefix (e.g., prefix 1601) to allow for greater addressing. The base field 1756 specifies a base register to use. In some examples, the base field 1756 is supplemented with an additional bit from a prefix (e.g., prefix 1601) to allow for greater addressing. In practice, the content of the scale field 1752 allows for the scaling of the content of the index field 1754 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1607 provides this value. Additionally, in some examples, a displacement factor usage is encoded in the MOD field of the addressing information field 1605 that indicates a compressed displacement scheme for which a displacement value is calculated and stored in the displacement field 1607.

In some examples, the immediate value field 1609 specifies an immediate value for the instruction. An immediate value may be encoded as a 1-byte value, a 2-byte value, a 4-byte value, etc.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Furthermore, the disclosure describes various examples in detail as noted above. Further examples are noted below that can be implemented:

Example 1. An apparatus comprising:
a chunky partial logic to identify overlap of partial load to store forwarding in a load pipeline for a load, decompose the load into chunks of uniform size for issuance of each chunk as a separate chunky load and schedule the issuance of the chunks; and
a chunky partial register to receive and store the chunks decomposed into the chunks and issue the chunks separately into the load pipeline as a load operation.

Example 2. The apparatus of Example 1 further comprising:
a data register to collect separate results of load pipeline operations on processing the chunks at an output of the load pipeline and merge the separate results upon completion of collecting the separate results.

Example 3. The apparatus according to Examples 1-2, wherein a size of the chunks of uniform size is determined by the overlap of the load and store of the partial load to store forwarding.

Example 4. The apparatus according to Examples 2, wherein the size is further determined by an alignment of the load, store and the overlap.

Example 5. The apparatus according to Examples 2-4, wherein the size is 4-bytes when the load and store are aligned.

Example 6. The apparatus according to Examples 2-4, wherein the size defaults to 1-byte when the load and store are misaligned.

Example 7. The apparatus according to Example 1, wherein issuance of each chunk asserts a chunk bit as an indicator to indicate a chunk load operation to the load pipeline.

Example 8. The apparatus according to Example 7, wherein the issuance of a last chunk asserts a last chunk indicator to indicate a last chunk to be collected for completion of separate chunk load operations for the load.

Example 9. A method comprising:
identifying an overlap of partial load to store forwarding in a load pipeline for a load;
decomposing the load into chunks of uniform size for issuing each chunk as a separate chunky load;
issuing the decomposed chunks separately into the load pipeline as a set of load operations; and
collecting separate results of the set of load operations on processing the chunks at an output of the load pipeline to merge the separate results.

Example 10. The method according to Example 9, wherein a size of the chunks of uniform size is determined by the overlap of the load and store of the partial load to store forwarding.

Example 11. The method according to Example 10, wherein the size is further determined by an alignment of the load, store and the overlap.

Example 12. The method according to Example 11, wherein the size is 4-bytes when the load and store are aligned and the size defaults to 1-byte when the load and store are misaligned.

Example 13. The method according to Examples 9-11 further comprising asserting a chunk bit as an indicator to indicate a chunk load operation to the load pipeline.

Example 14. The method according to Example 13 further comprising asserting a last chunk indicator to indicate a last chunk to be collected for completion of separate chunk load operations for the load.

Example 15. The method according to Examples 9-14 further comprising indicating a failed chunk load operation for a chunk in the load pipeline to invalidate merging of the separate results as an invalid output.

Example 16. A system comprising:
a load pipeline;
a chunky partial logic to identify overlap of partial load to store forwarding in the load pipeline for a load, decompose the load into chunks of uniform size for issuance of each chunk as a separate chunky load and schedule the issuance of the chunks;
a chunky partial register to receive and store the chunks decomposed into the chunks and issue the chunks separately into the load pipeline as a load operation; and
storage to collect separate results of load pipeline operations on processing the chunks at an output of the load pipeline and merge the separate results upon completion of collecting the separate results.

Example 17. The system according to Example 16, wherein a size of the chunks of uniform size is determined by the overlap of the load and store of the partial load to store forwarding.

Example 18. The system according to Example 17, wherein the size is further determined by an alignment of the load, store and the overlap.

Example 19. The system according to Example 18, wherein the load pipeline indicates a failed chunk load operation for a chunk in the load pipeline to invalidate the merge of the separate results as an invalid output.

Example 20. The system according to Examples 16-18, wherein the storage is a store buffer or a cache memory.

What is claimed is:

1. An apparatus comprising:
a chunky partial logic to identify overlap of partial load to store forwarding in a load pipeline for a load, decompose the load into chunks of uniform size for issuance of each chunk as a separate chunky load and schedule the issuance of the chunks; and
a chunky partial register to receive and store the chunks decomposed into the chunks and issue the chunks separately into the load pipeline as a load operation.

2. The apparatus of claim 1 further comprising:
a data register to collect separate results of load pipeline operations on processing the chunks at an output of the load pipeline and merge the separate results upon completion of collecting the separate results.

3. The apparatus according to claim 1, wherein a size of the chunks of uniform size is determined by the overlap of the load and store of the partial load to store forwarding.

4. The apparatus according to claim 3, wherein the size is further determined by an alignment of the load, store and the overlap.

5. The apparatus according to claim 4, wherein the size is 4-bytes when the load and store are aligned.

6. The apparatus according to claim 4, wherein the size defaults to 1-byte when the load and store are misaligned.

7. The apparatus according to claim 1, wherein issuance of each chunk asserts a chunk bit as an indicator to indicate a chunk load operation to the load pipeline.

8. The apparatus according to claim 7, wherein the issuance of a last chunk asserts a last chunk indicator to indicate a last chunk to be collected for completion of separate chunk load operations for the load.

9. A method comprising:
identifying an overlap of partial load to store forwarding in a load pipeline for a load;
decomposing the load into chunks of uniform size for issuing each chunk as a separate chunky load;
issuing the decomposed chunks separately into the load pipeline as a set of load operations; and
collecting separate results of the set of load operations on processing the chunks at an output of the load pipeline to merge the separate results.

10. The method according to claim 9, wherein a size of the chunks of uniform size is determined by the overlap of the load and store of the partial load to store forwarding.

11. The method according to claim 10, wherein the size is further determined by an alignment of the load, store and the overlap.

12. The method according to claim 11, wherein the size is 4-bytes when the load and store are aligned and the size defaults to 1-byte when the load and store are misaligned.

13. The method according to claim 9 further comprising asserting a chunk bit as an indicator to indicate a chunk load operation to the load pipeline.

14. The method according to claim 13 further comprising asserting a last chunk indicator to indicate a last chunk to be collected for completion of separate chunk load operations for the load.

15. The method according to claim 14 further comprising indicating a failed chunk load operation for a chunk in the load pipeline to invalidate merging of the separate results as an invalid output.

16. A system comprising:
a load pipeline;
a chunky partial logic to identify overlap of partial load to store forwarding in the load pipeline for a load, decompose the load into chunks of uniform size for issuance of each chunk as a separate chunky load and schedule the issuance of the chunks;
a chunky partial register to receive and store the chunks decomposed into the chunks and issue the chunks separately into the load pipeline as a load operation; and
storage to collect separate results of load pipeline operations on processing the chunks at an output of the load pipeline and merge the separate results upon completion of collecting the separate results.

17. The system according to claim 16, wherein a size of the chunks of uniform size is determined by the overlap of the load and store of the partial load to store forwarding.

18. The system according to claim 17, wherein the size is further determined by an alignment of the load, store and the overlap.

19. The system according to claim 18, wherein the load pipeline indicates a failed chunk load operation for a chunk in the load pipeline to invalidate the merge of the separate results as an invalid output.

20. The system according to claim 18, wherein the storage is a store buffer or a cache memory.
